(19) United States
(12) Patent Application Publication
(10) Pub. No.: US 2024/0250834 A1
(43) Pub. Date: Jul. 25, 2024

(54) MECHANISM FOR CRYPTOGRAPHIC DIGITAL SIGNATURES USING GEODETIC BOUNDARIES

(71) Applicant: David Stavetski, Wylie, TX (US)

(72) Inventor: David Stavetski, Wylie, TX (US)

(21) Appl. No.: 18/623,008

(22) Filed: Mar. 31, 2024

(51) Int. Cl. H04L 9/32; H04W 12/64

(52) U.S. Cl. CPC H04L 9/3247; H04W 12/64

(57) ABSTRACT

This invention is a mechanism for cryptographic signature, the criteria for which is a self-selected collection of geospatial boundaries represented by irregular n-sided polygons. The endpoints of these polygons are calculated from a receiver inside a device which stores an interval of geodetic data points. In their collective the digits of these data points are concatenated into a seed phrase for input into an asymmetric elliptic cryptographic method to produce a public and private key pair. The arithmetic mean of this collective will provide a boundary within which the device will respond to short-range wireless communications and outside of which the device will be silent. The details of these boundary extents and the associated private key are not able to be recorded or duplicated, yet the location where signing may occur is approximate and simple enough to remember which obviates the need for recording or a trusted third party.

### CROSS-REFERENCES TO RELATED APPLICATIONS

Not Applicable

### STATEMENT OF GOVERNMENT INTEREST

Not Applicable

### BACKGROUND OF THE INVENTION

This invention relates to cryptographic mechanisms for secure communication, specifically as it relates to the calculation of cryptographic keys or passwords involving random seeds and using geo-location information.

As the number of internet devices and internet services continue to increase, combined with the advent of artificial intelligence, the need for more stringent methods of security and protection for the Owner of the underlying data is critical. The push for greater security and stronger passwords has led to longer and more random strings of characters which strain the limits of human memory and lead to the recording of a password onto a physical medium, a practice which may lead to passwords being lost or stolen. Additionally an Owner may employ a trusted third party for password management. In this case trust of vital data is often bestowed to the same party requiring security which poses additional risk or a single point of failure.

Multi-Factor Authentication (MFA) is a method which validates an Owner's identity by requiring a response from additional means not related to password verification, for example an email, phone number or biometric device such as a fingerprint. While MFA increases security it also creates a more tedious experience for the Owner while simultaneously requiring the Owner to divulge more vital data, which may lead to additional compromise.

Elliptic signature algorithms introduce a method for the generation of public and private key pairs. The public key is issued to a person with whom an Owner wishes to communicate. An Owner encrypts a message using the private key, and by decrypting the message with the public key, the person verifies the identity of the Owner. While this method does not require the use of a trusted third party, it requires lengthy strings of characters in order to reduce the likelihood of brute force attacks, which again strain the limits of human memory or force an Owner to record the key onto a physical medium.

The invention in U.S. Pat. No. 9,729,318B2 by Hoy et. al. describes a method for digital representation of an everyday object as a means to generate public and private key pairs. In this method an Owner self-selects a personal object thereby simplifying the requirement for memory. However, the reproducibility of this digital representation poses a challenge and implementation likely requires a third party.

The introduction of mnemonic seed phrases to create pairs of public and private keys is an enhancement to the elliptical signature algorithm in that it is simpler in practice to utilize twelve or twenty four random words rather than a lengthy string of random characters. However the seed phrase still requires recording.

Location identification using coordinates from the Global Positioning System has been used for security, encryption and cryptographic keys. The invention by Ronca US 2015/0271155A1 uses the construct of a geo-fence to alter cryptographic key material and to control access between devices and the operators of these devices. Management of these keys is performed by a trusted third party.

### BRIEF STATEMENT OF THE INVENTION

The object of this invention is a mechanism for cryptographic signature, the criteria for which is a self-selected collection of geospatial boundaries represented by irregular n-sided polygons. The endpoints of these polygons are calculated from a receiver inside a device which stores an interval of geodetic data points. In their collective the digits of these data points are concatenated into a seed phrase for input into an asymmetric elliptic cryptographic method to produce a public and private key pair. The arithmetic mean of this collective will provide a boundary within which the device will respond to short-range wireless communications for cryptographic signature and outside of which the device will be silent. The details of these boundary extents and the associated private key are stored within the device and are inaccessible and not able to be recorded, yet the location where signing may occur is approximate and simple enough to remember which obviates the need for recording or a trusted third party.

### BRIEF DESCRIPTION OF DRAWINGS

FIG. 1 is an illustration of a cluster of endpoints and the resulting mean surface for an n-sided polygon (n=4), showing the triangularization necessary to determine interior points.

FIG. 2 is an illustration of a device with core components and an operating flow chart for digital signing.

### DETAILED DESCRIPTION OF THE INVENTION

The Global Navigation Satellite Systems (GNSS) encompasses constellations of satellites in geosynchronous position around the Earth. These include the US owned GPS system, Russian owned GLONASS, Europe's Galileo and China's BeiDou. Additionally there are regional augmentation systems which provide greater precision of position including vertical elevation and velocity. Each system works on a similar principle where a satellite sends a radio message containing a time reference from an atomic clock. The position on Earth of a receiver is calculated knowing satellite positions, time differences, and a specific coordinate reference ellipsoid approximation for the Earth, most commonly WGS84.

The accuracy of the position calculation is affected by many factors including the processing power of the receiver, the signal to noise ratio and the types of correction algorithms available within the satellites and the receiver, for example corrections for doppler effects and clock drift. Additional data from supplemental augmentation systems help increase accuracy, including data from Continually Operating Reference Systems (CORS). As consumer demands drive refinement of positional accuracy, other factors may need to be accounted for, including the ellipsoid approximation and the effects of crustal dynamics, as the Earth's tectonic plates move approximately up to one inch per year. Currently recreational GPS receivers are often accurate to within 1 to 3 meters and surveying receivers which require more power and advanced configuration may be accurate to less than 1 meter.

A common notation for expressing geolocation coordinates is decimal degrees, which uses the following syntax: (+−) hh.mmmmmm. The sign of the number refers to the quadrant of the globe, while the tens digit may indicate the continent. The unit digit reflects the state or country, and the remaining decimal digits refine the location. The first decimal digit may indicate a city, the fourth digit a parcel of land, the fifth a room inside a house, and the sixth an object within the room. The number of decimal digits reported by the receiver is the precision of the calculation. Since the position is a calculated quantity it is very likely that the precision may exceed the accuracy of the receiver. The spread between accuracy and precision is a measure of inexactness, which this invention uses as a source of entropy for cryptographic input.

The invention will collect positions from a GPS receiver over a time interval of random length. This set of data serves as input for two separate calculations.

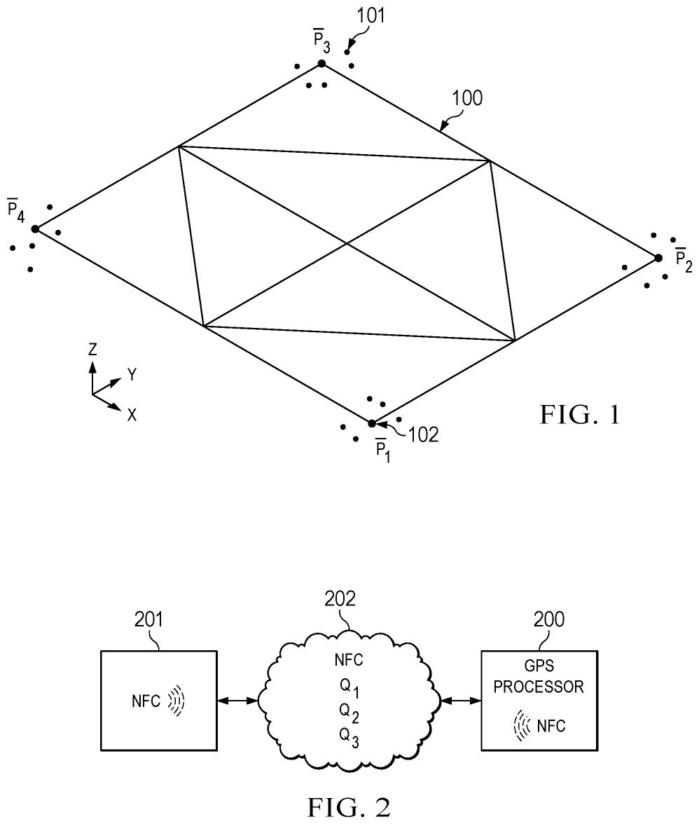

First, it is used as a pseudo-centroid for an n-sided polygon. FIG. 1 illustrates a collection of data points for a four sided polygon over an interval of five periods. 101 depicts a cluster of endpoints, one for each period in the time interval, while 102 represents the average. Together the average points P1, P2, P3 and P4 form the corners of a geometric boundary 100. The boundary as illustrated is triangularized, which can be performed by common methods of computational geometry, for the purpose of determining whether any given point is inside or outside the boundary.

Second, each point within the endpoint cluster (101) contains three spatial coordinates: latitude, longitude and vertical, or X, Y and Z in a transformed coordinate system. Currently, asset tracking devices for fleet or inventory management adhere to Automotive Industry Standards 140 (AIS 140) which represents coordinates in decimal degrees to six decimal digits. This requires 8 digits for latitude and 9 digits for longitude. The accuracy of vertical positioning is less than the horizontal coordinates and may be specified with 7 digits. When these digits are concatenated each point in the endpoint cluster (101) is represented by a character string of length 24. In the example provided, a four sided polygon over five time periods would result in a seed phrase of length 480, which is used as input into an asymmetric elliptical cryptography algorithm. Over time as the accuracy of receivers increases so will the number of digits required for precision. This will result in a seed phrase of greater length, but the method for generating this seed phrase described by this invention will still be viable.

An embodiment of this invention is a device containing a GPS receiver, a computer processor, and a short-range radio device, for example chipsets near field communications (NFC) or ultra-wideband (UWB). At a time of an Owner's choosing the device will begin to record horizontal and vertical coordinates from which it can calculate endpoints of a boundary. After a specified time the endpoints are concatenated into a seed phrase and used as input to an elliptic curve digital signature algorithm. The output of this algorithm is a pair of public and private keys which are stored in memory. The endpoints are also averaged into a mean surface and subdivided into a set of triangles. From this moment forward every GPS reading will trigger a point in polygon calculation to determine if the geopositional location of the device is within the mean boundary. If yes, the limited range radio is activated and if not the limited range radio is disabled.

The short range radio is the only interface to the device and may be capable of NFC communications, a common mechanism for contactless payment systems. As illustrated in FIG. 2 the device (200) will support only a handful of operations across an NFC channel (202) when in proximity of a second NFC enabled device (202) First, a simple query which will return a public key to be shared with other systems for digital signature or verification. Second, a verification query which will contain a message encrypted by the public key. The device will decrypt the message using the stored private key and return the message text thereby verifying ownership. Third, an encryption query where the message text will require encryption by the private key. Any other query or command sent to the device will be ignored. If the device is outside the boundary specified by an Owner, the interface will be inactive.

### BEST MODE OF OPERATION OF THE INVENTION

The best embodiment of this invention is to verify an identity for secure transactions as part of a standalone or MFA system, or as a checkpoint during a transfer of data between storage systems, for instance between software and/or hardware wallets for cryptocurrency. In this embodiment a device has already been instantiated and actively placed within the boundary set by an Owner. A service will ask an Owner to verify a previously issued public key or address. By tapping the device with a mobile computing device, or a peripheral attached to a stationary computing device, or any machine capable of NFC or UWB communication, and thereby establishing a channel, the verification process would be complete. Or, in the case of where data needs to be transferred, a message containing raw transactions would be signed, allowing the transfer to complete.

Although an embodiment has been described with reference to specific exemplary embodiments, it will be evident that various modifications and changes may be made thereto without departing from the broader spirit and scope of the embodiments as set forth in the appended claims. The specification and drawings are, accordingly, to be regarded in an illustrative sense rather than a restrictive sense. Combinations of the above embodiments not specifically described will be apparent to those of skill in the art upon reviewing the above description.

Having described the invention, what is claimed is:

1. A mechanism for cryptographic signatures using a time interval of geodetic coordinates from which the corners of n-sided polygons are computed, a set of which are concatenated into a seed phrase for generation of cryptographic keys, the average of which form a geographic boundary within which a channel for communication may exist and outside of which a channel for communication will not.

2. Using the method of claim 1, a device which contains any number of computer chips or processors to perform the following functions: receive GNSS signals from a satellite and convert them into a position, and then based on this position create endpoints for boundaries of random n-sided boundaries, and then perform tests to determine if GNSS positions are within this boundary, and if so communicate through a short-range radio channel and perform a limited number of cryptographic tasks including the decryption and encryption of messages.
